(19) United States
(12) Patent Application Publication
(10) Pub. No.: US 2025/0225950 A1
(43) Pub. Date: Jul. 10, 2025

(54) REMOTE CONTROL OF FUNCTIONAL PARAMETERS AND RENDERING OF OPERATIONAL PREVIEW OF ELECTRONIC DEVICE

(71) Applicant: SONY GROUP CORPORATION, TOKYO (JP)

(72) Inventors: PETER SHINTANI, SAN DIEGO, CA (US); ARTURO JORDAN, SAN DIEGO, CA (US); FRED W ANSFIELD, SAN DIEGO, CA (US)

(21) Appl. No.: 18/404,315

(22) Filed: Jan. 4, 2024

(51) Int. Cl. G09G 5/00; H04R 5/04

(52) U.S. Cl. CPC G09G 5/006; H04R 5/04; G09G 2320/0626; G09G 2320/066; G09G 2320/0666; G09G 2320/068; G09G 2340/0407; H04R 2420/01

(57) ABSTRACT

A first electronic device and a method for controlling functional parameters and rendering operational preview of a second electronic device are provided. The first electronic device receives a user input indicative of control commands to operate the second electronic device associated with first electronic device. The first electronic device determines a requested set of changes in the value of a functional parameter, based on the received user input. The first electronic device controls the second electronic device to operate based on the determined requested set of changes. The first electronic device or the second electronic device is controlled to render a first operational preview associated with the determined requested set of changes, based on the control of the second electronic device.

### FIELD

Various embodiments of the disclosure relate to remote control. More specifically, various embodiments of the disclosure relate to a first electronic device, a second electronic device and a method for remote control of functional parameters and rendering of operational preview based on functional parameters.

### BACKGROUND

Advancements in technology have led to development of operational or functional control of any electronic device using a remote controller. The remote controller devices control various electronic devices, such as radio sets, television sets, DVD players and other home appliances. A remote controller communicates with an associated electronic device through a short distance wireless communication network to conveniently operate the electronic device. For example, the remote controller works on the principle of infrared (IR) or Radio Frequencies (RF), where the remote controller sends digitally encoded pulses of IR radiation from the remote controller to the electronic device associated with the remote controller. The digitally encoded pulses of IR or RF are sent with the instructions to control functionalities of the electronic device, such as, volume control, channel surfing, power control of the electronic devices. The remote controllers are designed to have a plurality of control buttons for functionality control. Furthermore, today's remote controllers may be based on advanced technology that may enable control of the functionalities of the electronic device through a gesture input or audio input from a user received via the remote controller. The issue with the current technology is that while the control of electronic devices, such as, display devices, using remote controllers may be cumbersome as there may be a variety of settings that may be controllable, the user may have a desire to experience an enhanced control over the settings without additional effort.

Limitations and disadvantages of conventional and traditional approaches will become apparent to one of skill in the art, through comparison of described systems with some aspects of the present disclosure, as set forth in the remainder of the present application and with reference to the drawings.

### SUMMARY

An electronic device and method for remote control of functional parameters and rendering of operational preview of electronic device is provided substantially as shown in, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram that illustrates an exemplary communication network environment for remotely controlling a plurality of functional parameters of a second electronic device and rendering of operational preview of a first electronic device, in accordance with an embodiment of the disclosure.

FIG. 2A is a block diagram that illustrates an exemplary first electronic device 102 of FIG. 1, in accordance with an embodiment of the disclosure.

FIG. 2B is a block diagram that illustrates an exemplary second electronic device 104 of FIG. 1, in accordance with an embodiment of the disclosure.

FIG. 3A is a diagram that illustrates an exemplary processing pipeline for remote controlling of functional parameters and rendering of operational preview of an electronic device, in accordance with an embodiment of the disclosure.

FIG. 3B is a diagram that illustrates an exemplary processing pipeline for remote controlling of functional parameters and rendering of operational preview of an electronic device, in accordance with an embodiment of the disclosure.

FIG. 4 is a diagram that illustrates an exemplary scenario of a remote controller controlling a display device, in accordance with an embodiment of the disclosure.

FIG. 5 is a diagram that illustrates an exemplary scenario of change in display pixels according to the user input, in accordance with an embodiment of the disclosure.

FIG. 6 is a flowchart that illustrates operations of an exemplary method for remote control of functional parameters and rendering of operational preview of electronic device, in accordance with an embodiment of the disclosure.

### DETAILED DESCRIPTION

The following described implementation may be found in a remote control of functional parameters and to render operational preview of electronic device. Exemplary aspects of the disclosure may provide a first electronic device that may receive a user input indicative of one or more control commands to operate a second electronic device associated with the first electronic device. The one or more control commands may correspond to a requested set of changes in values of one or more functional parameters of the second electronic device. The first electronic device may determine the requested set of changes in the values of the one or more functional parameters, based on the received user input. Thereafter, the first electronic device may control the second electronic device to operate based on the determined requested set of changes in the values of the one or more functional parameters. Further, the first electronic device may control, at least one of the first electronic device or the second electronic device, to render a first operational preview associated with the determined requested set of changes, based on the control of the second electronic device.

The first electronic device of the present disclosure may provide remote control of functional parameters and to render of operational preview of the second electronic device. In order to do so, the first electronic device may receive one or more control commands associated with the second electronic device from a user. The one or more control commands may correspond to a requested set of changes in values of one or more functional parameters of the second electronic device. Thereafter, in some embodiments, the first electronic device may determine the requested set of changes in the values of the one or more functional parameters based on the received user input. Further, based on the determined requested set of changes in the values of the one or more functional parameters, the first electronic device may control the second electronic device. Upon control of the second electronic device, the first electronic device may render a first operational preview associated with the determined requested set of changes. Furthermore, the second electronic device is controlled to render an on-screen display (OSD) menu on the second electronic device. The OSD menu corresponds to the one or more functional parameters to be changed. The disclosed first electronic device may thereby be enabled to receive a current value of the each of the one or more functional parameters and control the first electronic device to render a second operational preview associated with the received current value of the each of the one or more functional parameters. Therefore, the disclosed first electronic device may be incorporated in applications such as, television, broadcast monitor, computer displays or any device that requires functional parameters control.

Typically, usage of a remote control to control functional parameters of a certain device may be cumbersome in case a user wishes to control multiple functional parameters concurrently. Also, the user may have a desire to preview the changes in the multiple functional parameters concurrently on a display of the device being controlled. Traditionally, the display of an electronic device (such as, a television) being controlled not allow a preview of the changes of such multiple functional parameters concurrently as the display of the electronic device may show an on-screen display (OSD) menu overlaid on the entire or a majority of portion of the display. On the contrary, the present disclosure provides a first electronic device (such as, a remote controller) that may be used to preview and change a plurality of functional parameters of a second electronic device (i.e., a device being controlled, such as, a television). The first electronic device may render an operational preview of current values of the multiple functional parameters of the second electronic device. The first electronic device may also render an operation preview of the updated values of the multiple functional parameters of the second electronic device. The OSD menu may be inactivated on the second electronic device and as the operational previews are rendered on the first electronic device, the user may enjoy uninterrupted playback of content on the second electronic device. Also, in certain cases, the operational preview of the updated values of the multiple functional parameters may be rendered on the second electronic device for the user to have a better experience of the updated values of the functional parameters. Thus, the viewing experience of the second electronic device may be improved for the user.

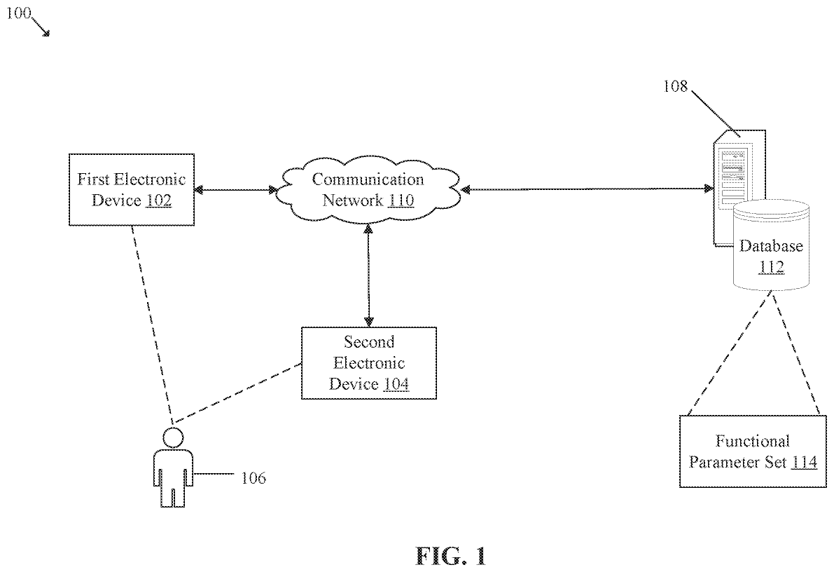

FIG. 1 is a block diagram that illustrates an exemplary network environment for a remote control of functional parameters and to render operational preview of electronic device, in accordance with an embodiment of the disclosure. With reference to FIG. 1, there is shown a network environment 100. The network environment 100 may include a first electronic device 102, a second electronic device 104, a server 108, and a database 112. The first electronic device 102, the second electronic device 104, and the server 108 (and/or the database 112) may be interconnected through one or more networks, such as, the communication network 110. The database 112 may be configured to store a functional parameter set 114 corresponding to a set of controllable functional parameters of the second electronic device 104. There is further shown a user 106, who may be associated with and/or operate the first electronic device 102 and/or second electronic device 104.

The first electronic device 102 may include suitable logic, circuitry, interfaces, and/or code that may be configured to receive a control command associated with the user 106. The first electronic device 102 may receive a user input to operate the second electronic device 104 associated with the first electronic device 102. The user input may include control commands corresponding to a requested set of changes in values of one or more functional parameters of the second electronic device 104. The first electronic device 102 may determine the requested set of changes in the values of the one or more functional parameters, based on the received user input. The first electronic device 102 may control the second electronic device 104 to operate based on the requested set of changes in the values of the one or more functional parameters. The first electronic device 102 may control at least one of the first electronic device 102 or the second electronic device 104, to render a first operational preview associated with the determined requested set of changes, based on the control of the second electronic device 104.

Examples of the first electronic device 102 may include, but are not limited to, a computing device, a smartphone, a cellular phone, a mobile phone, a gaming device, a mainframe machine, a remote controller, a server, a computer workstation, a remote control device (enabled with or hosting, for example, a computing resource, a memory resource, and a networking resource), a jockey stick with an inbuilt signal emitter, and/or a consumer electronic (CE) device.

The second electronic device 104 may include suitable logic, circuitry, interfaces, and/or code that may be configured to render media content. Operations of the second electronic device 104 may be controlled based on a plurality of functional parameters associated with the second electronic device 104. For example, the plurality of functional parameters may include, but are not limited to, display parameters, audio parameters, and media parameters. The second electronic device 104 may determine the changes in the values of the one or more functional parameters, based on the requested set of changes in values of the one or more functional parameters on the first electronic device 102. The second electronic device 104 may render the requested changes in the value of the one or more functional parameters. Furthermore, the second electronic device 104 may display the effects of the rendered value of the one or more functional parameters on the screen. Examples of the second electronic device 104 may include, but are not limited to, a computing device, a smartphone, a cellular phone, a mobile phone, a gaming device, a television, a mainframe machine, a server, a computer workstation, a media playback device (enabled with or hosting, for example, a computing resource, a memory resource, and a networking resource), and/or a consumer electronic (CE) device.

The server 108 may include suitable logic, circuitry, and interfaces, and/or code that may be configured to receive the control command associated with the user 106. The server 108 may receive the user input to operate the second electronic device 104 associated with the first electronic device 102. The user input may include control commands corresponding to a requested set of changes in values of one or more functional parameters of the second electronic device 104. The server 108 may determine the requested set of changes in the values of the one or more functional parameters, based on the received user input. The server 108 may control the second electronic device 104 to operate based on the requested set of changes in the values of the one or more functional parameters. The server 108 may control at least one of the first electronic device 102 or the second electronic device 104, to render a first operational preview associated with the determined requested set of changes, based on the control of the second electronic device 104.

The server 108 may be implemented as a cloud server and may execute operations through web applications, cloud applications, HTTP requests, repository operations, file transfer, and the like. Other example implementations of the server 108 may include, but are not limited to, a database server, a file server, a web server, a media server, an application server, a mainframe server, a machine learning server (enabled with or hosting, for example, a computing resource, a memory resource, and a networking resource), or a cloud computing server.

In at least one embodiment, the server 108 may be implemented as a plurality of distributed cloud-based resources by use of several technologies that are well known to those ordinarily skilled in the art. A person with ordinary skill in the art will understand that the scope of the disclosure may not be limited to the implementation of the server 108, the first electronic device 102 and the second electronic device 104, as separate entities. In certain embodiments, the functionalities of the server 108 can be incorporated in its entirety or at least partially in the first electronic device 102 or the second electronic device 104 without a departure from the scope of the disclosure. In certain embodiments, the server 108 may host the database 112. Alternatively, the server 108 may be separate from the database 112 and may be communicatively coupled to the database 112.

The database 112 may include suitable logic, interfaces, and/or code that may be configured to store the functional parameter set 114. The database 112 may be derived from data off a relational or non-relational database, or a set of comma-separated values (csv) files in conventional or big-data storage. The database 112 may be stored or cached on a device, such as a server (e.g., the server 108) or the first electronic device 102 or the second electronic device 104. The device stores the database 112. The database 112 may be configured to receive a query for one or more control commands to operate the second electronic device 104, from the first electronic device 102 or the server 108. In response, the device of the database 112 may be configured to retrieve and provide the queried control commands to the first electronic device 102 or the server 108, based on the received query.

In some embodiments, the database 112 may be hosted on a plurality of servers stored at the same or different locations. The operations of the database 112 may be executed using hardware including a processor, a microprocessor (e.g., to perform or control performance of one or more operations), a field-programmable gate array (FPGA), or an application-specific integrated circuit (ASIC). In some other instances, the database 112 may be implemented using software.

The communication network 110 may include a communication medium through which the first electronic device 102, the second electronic device 104 and the server 108 may communicate with one another. The communication network 110 may be one of a wired connection or a wireless connection. Examples of the communication network 110 may include, but are not limited to, the Internet, a cloud network, Cellular or Wireless Mobile Network (such as Long-Term Evolution and 5th Generation (5G) New Radio (NR)), satellite communication system (using, for example, low earth orbit satellites), a Wireless Fidelity (Wi-Fi) network, a Personal Area Network (PAN), a Local Area Network (LAN), or a Metropolitan Area Network (MAN). Various devices in the network environment 100 may be configured to connect to the communication network 110 in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols.

The functional parameter set 114 may include parameters such as, a brightness, a contrast, a sharpness, a smoothness, a focus, a resolution, a jitter, a temporal instability, a refresh rate, a color, a volume, an echo, a bass, and the like, associated with an operation of the second electronic device 104. In an embodiment, one or more of the functional parameter set 114 may be received as a user input from the user 106 to control an operation of the second electronic device 104. The user input may include a control command to request a set of changes in the values of the one or more of the functional parameter set 114. For example, the first electronic device 102 may receive the user input including the control command associated with the request to change values of the one or more of the functional parameter set 114. Based on the received user input, the first electronic device 102 may control an operation of the second electronic device 104. Accordingly, the second electronic device 104 may operate with updated values of the one or more of the functional parameter set 114.

In operation, the first electronic device 102 may receive the one or more control commands associated with the user 106. The first electronic device 102 may receive a user input indicative of the one or more control commands to operate the second electronic device 104 associated with the first electronic device 102. The control commands may correspond to a requested set of changes in values of one or more functional parameters (for example, the functional parameter set 114). For example, the functional parameter set 114 may include, but are not limited to, the brightness, the contrast, the sharpness, the smoothness, the focus, the resolution, the jitter, the temporal instability, the refresh rate, the color, the volume, the echo, the base, and the like, associated with an operation of the second electronic device 104. In an example, the one or more functional parameters may be associated to one or more of a display parameter, one or more of a media parameter and/or one or more of an audio parameter. Hence, the control commands may provide the information associated with the requested set of changes in the values of one or more functional parameters.

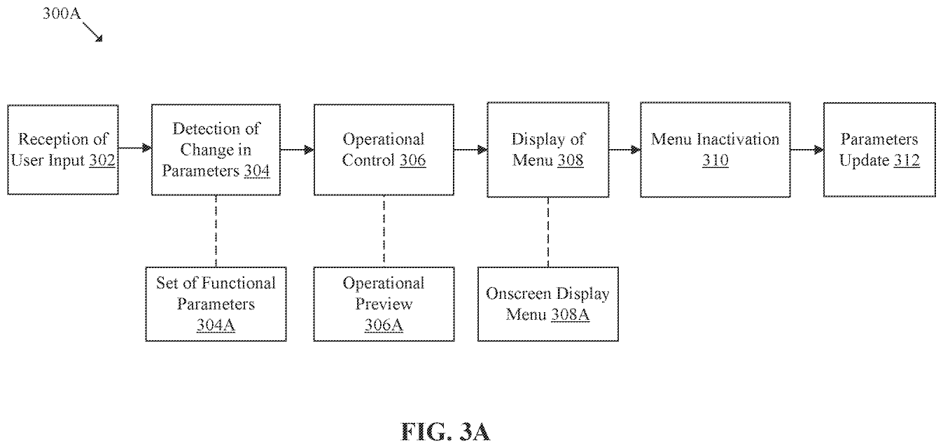

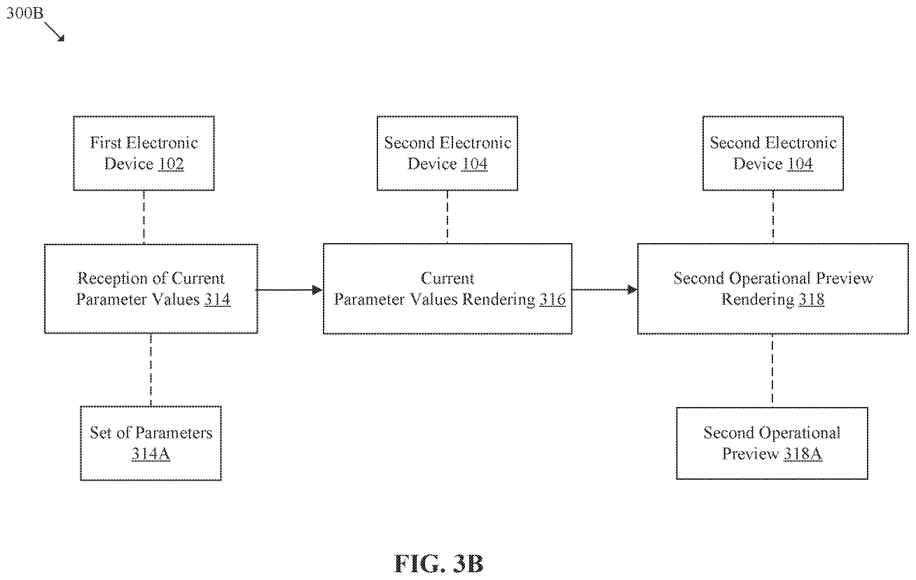

The first electronic device 102 may determine the requested set of changes in the values of the one or more functional parameters, based on the received user input. It may be appreciated that the changes in the values of the functional parameters may be in a predefined range. The predefined range may have a minimum value and a maximum value. The user input may provide information according to which the set of changes in the range of the values of the functional parameters may be identified. In an example, the received user input indicative of one or more control commands may be a set of values of the predefined range of values of one or more of the functional parameters. It may also be noted that the requested set of changes may correspond to a concurrent update of values of a plurality functional parameters of the one or more functional parameters. That is, the plurality functional parameters of the one or more functional parameters may be updated concurrently as per the received user input. Details related to the determination of the requested set of changes in the values of the one or more functional parameters, based on the received user input are further described, for example, in FIG. 3A.

The first electronic device 102 may be configured to control the second electronic device 104 to be operated based on the determined requested set of changes in the values of the one or more functional parameters. The second electronic device 104 may be controlled by the first electronic device 102 based on the control commands received by the user input on the first electronic device 102. The second electronic device 104 may be operated based on the change in the values of the one or more functional parameters according to the control commands received by the user input on the first electronic device 102. The changes in that value of one or more functional parameters may alter one or more of the display parameter, one or more of the media parameter, and/or one or more of audio parameter. Details related to the control of the second electronic device 104 to be operated are further described, for example, in FIG. 3A.

The first electronic device 102 may be configured to control at least one of the first electronic device 102 or the second electronic device 104 to render a first operational preview. The first operational preview may be associated with the determined requested set of changes in the values of the one or more functional parameters. The one or more functional parameters may be associated to the second electronic device 104. For example, the control commands received in the user input may be associated with an update of values of two functional parameters, such as, a brightness parameter and a contrast parameter and the of the second electronic device 104. In such a scenario, the determined set of changes in the values of the brightness parameter and the contrast parameter may be operationally previewed on the first electronic device 102 or the second electronic device 104. Further, based on the user input, an output on a display screen of the second electronic device 104 may render content based on the updated brightness parameter and the updated contrast parameter of the second electronic device 104. Similarly, in case the control commands received by the user input is to operate the functional parameter, such as, the volume parameter of the second electronic device 104, then the determined set of changes in the values of the volume parameter is operationally previewed on the first electronic device 102 or the second electronic device 104. Further, based on the user input, content may be rendered on the second electronic device 104 based on the updated volume parameter. Herein, the volume of the speaker associated with the second electronic device 104 may be changed according to the changed value of the volume parameter as per the user input. Details related to rendering of the functional parameters and operational preview are further described, for example, in FIG. 3A.

The first electronic device 102 of the present disclosure may provide remote control of functional parameters of the second electronic device 104 and may also render operational preview of changed values of functional parameters on the second electronic device 104 and/or on the first electronic device 102. In order to do so, the first electronic device 102 may receive one or more control commands associated with the second electronic device 104 from the user 106. The control commands may correspond to a requested set of changes in values of one or more functional parameters of the second electronic device 104. Thereafter, in some embodiments, the first electronic device 102 may determine the requested set of changes in the values of the one or more functional parameters based on the received user input. Further, based on the determined requested set of changes in the values of the one or more functional parameters, the first electronic device 102 control the second electronic device 104. Upon control of the second electronic device 104, the first electronic device 102 renders a first operational preview associated with the determined requested set of changes. Furthermore, the second electronic device 104 is controlled to render an on-screen display (OSD) menu on the second electronic device 104. The OSD menu corresponds to the one or more functional parameters to be changed. The disclosed first electronic device 102 may thereby be enabled to receive a current value of the each of the one or more functional parameters and control the first electronic device 102 to render a second operational preview associated with the received current value of the each of the one or more functional parameters. Therefore, the disclosed first electronic device 102 may be incorporated in applications such as, television, broadcast monitor, computer displays or any device that requires functional parameters control.

Typically, usage of the remote control to control functional parameters of a certain device may be cumbersome in case a user wishes to control multiple functional parameters concurrently. Also, the user may have a desire to preview the changes in the multiple functional parameters concurrently on a display of the device being controlled. Traditionally, the display of an electronic device (such as, a television) being controlled may not allow a preview of the changes of such multiple functional parameters concurrently as the display of the electronic device may show an on-screen display (OSD) menu overlaid on the entire or a majority of portion of the display. On the contrary, the present disclosure provides the first electronic device (such as, a remote controller) that may be used to preview and change the plurality of functional parameters of a second electronic device (i.e., a device being controlled, such as, a television). The first electronic device may render an operational preview of current values of the multiple functional parameters of the second electronic device. The first electronic device may also render an operation preview of the updated values of the multiple functional parameters of the second electronic device. The OSD menu may be inactivated on the second electronic device and as the operational previews are rendered on the first electronic device, the user may enjoy uninterrupted playback of content on the second electronic device. Also, in certain cases, the operational preview of the updated values of the multiple functional parameters may be rendered on the second electronic device for the user to have a better experience of the updated values of the functional parameters. Thus, the viewing experience of the second electronic device may be improved for the user.

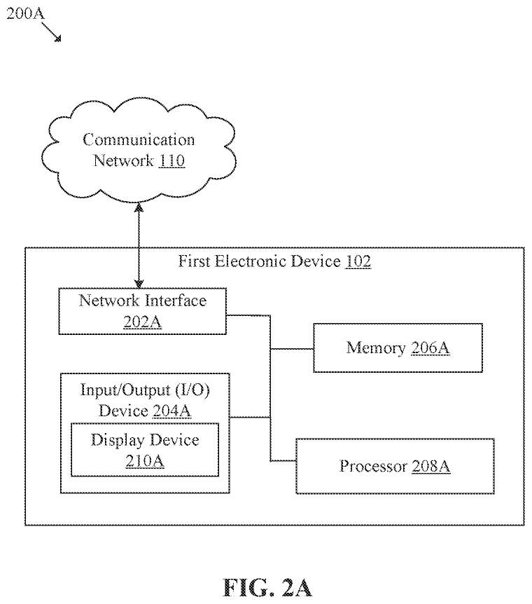

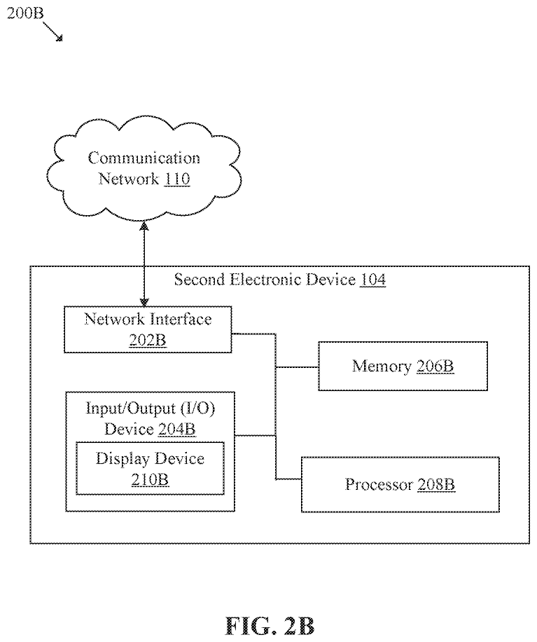

FIG. 2A is a block diagram that illustrates an exemplary first electronic device of FIG. 1, in accordance with an embodiment of the disclosure. FIG. 2A is explained in conjunction with elements from FIG. 1. With reference to FIG. 2A, there is shown the exemplary first electronic device 102. The first electronic device 102 may include a network interface 202A, an input/output (I/O) device 204A, a memory 206A, and a processor 208A. The memory 206A may store the functional parameter set 114. The input/output (I/O) device 204A may include a display device 210A.

The network interface 202A may include suitable logic, circuitry, interfaces, and/or code that may be configured to facilitate communication between the first electronic device 102, the second electronic device 104, and the server 108, via the communication network 110. The network interface 202A may be implemented by use of various known technologies to support wired or wireless communication of the first electronic device 102 with the communication network 110. The network interface 202A may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, or a local buffer circuitry.

The network interface 202A may be configured to communicate via wireless communication with networks, such as the Internet, an Intranet, a wireless network, a cellular telephone network, a wireless local area network (LAN), or a metropolitan area network (MAN). The wireless communication may be configured to use one or more of a plurality of communication standards, protocols and technologies, such as Global System for Mobile Communications (GSM), Enhanced Data GSM Environment (EDGE), wideband code division multiple access (W-CDMA), Long Term Evolution (LTE), 5th Generation (5G) New Radio (NR), code division multiple access (CDMA), time division multiple access (TDMA), Bluetooth, Wireless Fidelity (Wi-Fi) (such as IEEE 802.11a, IEEE 802.11b, IEEE 802.11g or IEEE 802.11n), voice over Internet Protocol (VoIP), light fidelity (Li-Fi), Worldwide Interoperability for Microwave Access (Wi-MAX), a protocol for email, instant messaging, and a Short Message Service (SMS).

The I/O device 204A may include suitable logic, circuitry, interfaces, and/or code that may be configured to receive an input and provide an output based on the received input. For example, the I/O device 204A may receive the user input indicative of one or more control commands to operate the second electronic device 104 associated with the first electronic device 102. The I/O device 204A may be further configured to display or render the changes in the value of the one or more functional parameter associated with the second electronic device 104, to be displayed on the first electronic device 102 or the second electronic device 104. The I/O device 204A may include the display device 210A. Examples of the I/O device 204A may include, but are not limited to, a display (e.g., a touch screen), a keyboard, a mouse, a joystick, a microphone, or a speaker. Examples of the I/O device 204a may further include braille I/O devices, such as, braille keyboards and braille readers.

The display device 210A may include suitable logic, circuitry, and interfaces that may be configured to the changes in the value of the one or more functional parameter associated with the second electronic device 104. The display device 210A may be a touch screen which may enable a user (e.g., the user 106) to provide the user input via the display device 210A. The touch screen may be at least one of a resistive touch screen, a capacitive touch screen, or a thermal touch screen. The display device 210A may be realized through several known technologies such as, but not limited to, at least one of a Liquid Crystal Display (LCD) display, a Light Emitting Diode (LED) display, a plasma display, or an Organic LED (OLED) display technology, or other display devices. In accordance with an embodiment, the display device 210A may be a display screen of a head mounted device (HMD), a smart-glass device, a see-through display, a projection-based display, an electro-chromic display, or a transparent display.

The memory 206A may include suitable logic, circuitry, interfaces, and/or code that may be configured to store one or more instructions to be executed by the processor 208A. The one or more instructions stored in the memory 206A may be configured to execute the different operations of the processor 208A (and/or the first electronic device 102). The memory 206A may be further configured to store the functional parameter set 114 and a set of changes in the values of the one or more functional parameters. Examples of implementation of the memory 206A may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The processor 208A may include suitable logic, circuitry, and/or interfaces that may be configured to execute program instructions associated with different operations to be executed by the first electronic device 102. The operations may include the control command reception, the reception of the one or more functional parameters, a requested set of changes in the values of the one or more functional parameters, a detection of the set of changes in the values, the control of the second electronic device 104 and the control of the rendering of the first operational preview. The processor 208A may include one or more processing units, which may be implemented as a separate processor. In an embodiment, the one or more processing units may be implemented as an integrated processor or a cluster of processors that perform the functions of the one or more specialized processing units, collectively. The processor 208A may be implemented based on a number of processor technologies known in the art. Examples of implementations of the processor 208A may be an X86-based processor, a Graphics Processing Unit (GPU), a Reduced Instruction Set Computing (RISC) processor, an Application-Specific Integrated Circuit (ASIC) processor, a Complex Instruction Set Computing (CISC) processor, a microcontroller, a central processing unit (CPU), and/or other control circuits. Various operations of the processor 208A for implementation of rendering of functional parameters based on the determined requested set of changes in the values of the one or more functional parameters are described further, for example, in FIGS. 3A and 3B.

FIG. 2B is a block diagram that illustrates an exemplary second electronic device of FIG. 1, in accordance with an embodiment of the disclosure. FIG. 2B is explained in conjunction with elements from FIG. 1. With reference to FIG. 2B, there is shown the exemplary second electronic device 104 including a network interface 202B, an input/output (I/O) device 204B, a memory 206B, and a processor 208B. The memory 206B may store the functional parameter set 114. The input/output (I/O) device 204B may include a display device 210B.

The network interface 202B may include suitable logic, circuitry, interfaces, and/or code that may be configured to facilitate communication between the second electronic device 104, the first electronic device 102, and the server 108, via the communication network 110. The network interface 202B may be implemented by use of various known technologies to support wired or wireless communication of the second electronic device 104 with the communication network 110. The network interface 202B may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, or a local buffer circuitry.

The network interface 202B may be configured to communicate via wireless communication with networks, such as the Internet, an Intranet, a wireless network, a cellular telephone network, a wireless local area network (LAN), or a metropolitan area network (MAN). The wireless communication may be configured to use one or more of a plurality of communication standards, protocols and technologies, such as Global System for Mobile Communications (GSM), Enhanced Data GSM Environment (EDGE), wideband code division multiple access (W-CDMA), Long Term Evolution (LTE), 5th Generation (5G) New Radio (NR), code division multiple access (CDMA), time division multiple access (TDMA), Bluetooth, Wireless Fidelity (Wi-Fi) (such as IEEE 802.11a, IEEE 802.11b, IEEE 802.11g or IEEE 802.11n), voice over Internet Protocol (VOIP), light fidelity (Li-Fi), Worldwide Interoperability for Microwave Access (Wi-MAX), a protocol for email, instant messaging, and a Short Message Service (SMS).

The I/O device 204B may include suitable logic, circuitry, interfaces, and/or code that may be configured to receive an input and provide an output based on the received input. For example, the I/O device 204B may receive the user input indicative of indicative of one or more control commands to operate the second electronic device 104 associated with the first electronic device 102. The I/O device 204B may be further configured to display or render the changes in the value of the one or more functional parameter associated with the second electronic device 104, based on the first operational preview displayed on the first electronic device 102 or the second electronic device 104. The I/O device 204B may include the display device 210B. Examples of the I/O device 204B may include, but are not limited to, a display (e.g., a touch screen), a keyboard, a mouse, a joystick, a microphone, or a speaker. Examples of the I/O device 204B may further include braille I/O devices, such as, braille keyboards and braille readers.

The display device 210B may include suitable logic, circuitry, and interfaces that may be configured to the changes in the value of the one or more functional parameters associated with the second electronic device 104. The display device 210B may be a touch screen which may enable a user (e.g., the user 106) to provide the user input via the display device 210B. The touch screen may be at least one of a resistive touch screen, a capacitive touch screen, or a thermal touch screen. The display device 210B may be realized through several known technologies such as, but not limited to, at least one of a Liquid Crystal Display (LCD) display, a Light Emitting Diode (LED) display, a plasma display, or an Organic LED (OLED) display technology, or other display devices. In accordance with an embodiment, the display device 210B may refer to a display screen of a head mounted device (HMD), a smart-glass device, a see-through display, a projection-based display, an electro-chromic display, or a transparent display.

The memory 206B may include suitable logic, circuitry, interfaces, and/or code that may be configured to store one or more instructions to be executed by the processor 208B. The one or more instructions stored in the memory 206B may be configured to execute the different operations of the processor 208B (and/or the second electronic device 104). The memory 206b may be further configured to store the functional parameter set 114 and a set of changes in the values of the one or more functional parameters. Examples of implementation of the memory 206B may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The processor 208B may include suitable logic, circuitry, and/or interfaces that may be configured to execute program instructions associated with different operations to be executed by the second electronic device 104. The operations may include the control command reception, the determination of the requested set of changes in the values of functional parameters, the rendering of the first operational preview, and the control of the second electronic device 104 based the requested set of changes in the values of functional parameters. The processor 208B may include one or more processing units, which may be implemented as a separate processor. In an embodiment, the one or more processing units may be implemented as an integrated processor or a cluster of processors that perform the functions of the one or more specialized processing units, collectively. The processor 208B may be implemented based on a number of processor technologies known in the art. Examples of implementations of the processor 208B may be an X86-based processor, a Graphics Processing Unit (GPU), a Reduced Instruction Set Computing (RISC) processor, an Application-Specific Integrated Circuit (ASIC) processor, a Complex Instruction Set Computing (CISC) processor, a microcontroller, a central processing unit (CPU), and/or other control circuits. Various operations of the processor 208B for implementation of rendering of functional parameters based on the determined requested set of changes in the values of the one or more functional parameters are described further, for example, in FIGS. 3A and 3B.

FIG. 3A is a diagram that illustrates an exemplary processing pipeline for remote controlling of functional parameters and rendering of operational preview of an electronic device, in accordance with an embodiment of the disclosure. FIG. 3A is explained in conjunction with elements from FIG. 1, FIG. 2A, and FIG. 2B. With reference to FIG. 3A, there is shown an exemplary processing pipeline 300A that illustrates exemplary operations from 302 to 312 for implementation of remote control of functional parameters and rendering of operational preview of the electronic device. The exemplary operations 302 to 312 may be executed by any computing system, for example, by the first electronic device 102 of FIG. 1 or by the processor 208A of FIG. 2A and by the second electronic device 104 of FIG. 1 or by the processor 208B of FIG. 2B. The processing pipeline 300A includes operational steps such as reception of user input 302, detection of change in parameters 304, operational control 306, display of menu 308, menu inactivation 310, and parameters update 312. In FIG. 3A, there is further shown, a set of functional parameters 304A, an operational preview 306A, and an onscreen display menu 308A.

At 302, an operation for user input reception may be executed. The processor 208A may be configured to receive the user input associated with the user 106. The user input may be indicative of one or more control commands. The user input may be obtained from user 106 via the first electronic device 102. For example, one or more buttons on the first electronic device 102 may be pressed by the user 106 to provide the user input. The plurality of control commands indicated by the user input is to operate the second electronic device 104 associated to the first electronic device 102. Further, the control commands correspond to a requested set of changes in values of one or more functional parameters of the second electronic device 104. Examples of control commands may include information, related to but not limited to, a display parameters, an audio parameters and a media parameters. Examples of the display parameter include, but are not limited to, a contrast parameter, a color parameter, a brightness parameter, a hue parameter, a display sharpness parameter, a display tint parameter, a parameter related to a viewing direction, or a resolution parameter. Examples of the audio parameter include, but are not limited to, a volume level, a sharpness level, an echo level, a parametric equalizer (EQ), a frequency parameter, an amplitude level, a timber parameter, a decibel level, or a noise cancellation parameter. Examples of the media parameter include, but are not limited to, a text font parameter, a resolution size parameter, a playback speed parameter, a temperature parameter, or a language).

In an embodiment, the control commands may correspond to the display parameters of the second electronic device 104. Herein, the first electronic device 102 may be a remote controller and the second electronic device 104 may be a media playback device, such as, a display screen that may be capable to playback audio video content. In an example, the instructions in the control commands may indicate that the brightness parameter and the display sharpness parameter values of the second electronic device 104 may be required to be changed concurrently. As already discussed, such control command may be received from the user 106 via the first electronic device 102, as a user input.

In an embodiment, the control commands may correspond to the audio parameters of the second electronic device 104. Herein, the first electronic device 102 may be a remote controller and the second electronic device 104 may be an audio output device, such as, a loudspeaker device or a media playback device with a capability to playback both audio and video associated with media content. In an example, the instructions in the control commands may indicate that the volume level and the parametric equalizer (EQ) of the second electronic device 104 may be required to be changed concurrently. As already discussed, such control command may be received from the user 106 via the first electronic device 102, as a user input.

At 304, an operation to determine the changes in functional parameters may be executed. The processor 208A may be configured to determine the requested change in the values of the functional parameters (such as, the set of functional parameters 304A). It should be noted that the received user input may correspond to the change in the value of one or more of functional parameters concurrently. The requested change in the values of the functional parameters may be used to alter or adjust the output of the second electronic device 104. In an example, the received control commands in the user input may be include instructions for the requested change in the values of the functional parameters such as, a display parameter, an audio parameter or a media parameter. The instructions corresponding to the control commands may be encoded in the received user input. The processor 208A may decode the instructions corresponding to the control commands in the received user input based on a look-up table of the control commands that may be stored on the memory 206A and/or the database 112. The changes in the values of the functional parameters of the control commands may be in a predefined range. The predefined range may have a minimum value and a maximum value, where the minimum value (e.g., 0% brightness) may be the lowest value that may be attained by a functional parameter (e.g., brightness) of the second electronic device 104 and the maximum value (e.g., 100% brightness) may be the highest value that may be attained by the functional parameter (e.g., brightness) of the second electronic device 104.

At 306, an operational control of the second electronic device 104 may be executed. The processor 208A may be configured to control the second electronic device 104 to operate based on the determined requested set of changes in the values of the one or more functional parameters (e.g., functional parameters from the set of functional parameters 304A). As discussed, the set of changes in the value of the functional parameters may be in a predefined range such that the functional parameters may be adjusted according to the user input. For example, the instructions in the control command received as the user input may indicate that the contrast parameter is to be changed from 35% to 65% and the brightness parameter is to be changed from 65% to 55%. Based on the decoding of the instructions in the control command, the processor 208A may control the processor 208B of the second electronic device 104 to operate the second electronic device 104. Accordingly, the contrast parameter of the second electronic device 104 may be updated to 65% and the brightness parameter may be updated to 55% (from 35% and 65%, respectively).

In an embodiment, the processor 208A may control, at least one of the first electronic device 102 or the second electronic device 104, to render a first operational preview (e.g., the operational preview 306A) associated with the determined requested set of changes, based on the control of the second electronic device 104. The operational preview 306A may be displayed to the user to identify the existing set of functional parameters or to identify control commands that corresponds to the requested set of changes in values of one or more functional parameters indicated by the user input. The operational preview 306A may be displayed on the first electronic device 102 or the second electronic device 104 to control the second electronic device 104. For example, the operational preview 306A may correspond to an audio and/or video rendition or preview of the updated values of the one or more functional parameters (of the set of functional parameters 304A) of the second electronic device 104. The operational preview 306A (i.e., the first operational preview) may be rendered on at least one of the first electronic device 102 or the second electronic device 104. For example, the updated brightness (set to 65%) and the updated contrast (set to 55%) may be rendered as an operational preview (for example, based on a rendering of a sample image with 65% brightness and 55% contrast) on the display device 210A of the first electronic device 102 and/or the display device 210B of the second electronic device 104.

At 308, an operation for the display of a menu may be executed. The processor 208B may be configured to control the second electronic device 104 to render the menu on the second electronic device 104, based on the received user input indicative of the control commands. It may be apparent that a requested set of changes in the value of the functional parameters correspond to the control commands indicated by the user input on the first electronic device 102 or the second electronic device 104.

For example, the processor 208A may control rendering of an on-screen display (OSD) menu corresponding to the one or more functional parameters that are to be changed according to the user input. In an embodiment, the OSD menu may be rendered on the second electronic device 104 based on the control commands indicated by the user input. In another embodiment, the OSD menu may also be rendered on the second electronic device 104.

At 310, an operation for menu inactivation may be executed. The processor 208B may be configured to control the second electronic device 104 based on the received user input. The second electronic device 104 may be controlled to inactivate the rendered OSD menu on the second electronic device 104. It may be apparent that the OSD menu may correspond to the functional parameters of the second electronic device 104 that may be required to be changed according to the user input on the first electronic device 102.

At 312, an operation for functional parameters update may be executed. The processor 208B may be configured to concurrently update the values of plurality of functional parameters of one or more functional parameters of the second electronic device 104 based on the received user input. The second electronic device 104 may be controlled to concurrently update the values of plurality of functional parameters. For example, the display parameters such as, brightness and contrast, and the audio parameters, such as, audio volume and parametric equalizer (EQ), may be four functional parameters that may be required to be changed based on the received user input. As discussed at 306, the operational preview of the updated parameters may be rendered on the first electronic device 102 and/or the second electronic device 104. Further, based on a confirmation from the user 106 on the operational preview, the second electronic device 104 may be controlled to set the values of the parameters according to the update.

FIG. 3B is a diagram that illustrates an exemplary processing pipeline for remote controlling of functional parameters and rendering of operational preview of an electronic device, in accordance with an embodiment of the disclosure. FIG. 3B is explained in conjunction with elements from FIG. 1, FIG. 2A, FIG. 2B, and FIG. 3A. With reference to FIG. 3B, there is shown an exemplary processing pipeline 300B that illustrates exemplary operations from 314 to 318 for implementation of remote control of functional parameters and rendering of operational preview of the electronic device. The exemplary operations 314 to 318 may be executed by any computing system, for example, by the first electronic device 102 of FIG. 1 or by the processor 208A of FIG. 2A or by the second electronic device 104 of FIG. 1 or by the processor 208B of FIG. 2B. The processing pipeline 300B includes operational steps such as reception of current values of functional parameters 314A, rendering of current parameter values 316, and rendering of second operational preview 318. In FIG. 3B, there is further shown, current parameter values 314A and a second operational preview 318A.

At 314, an operation for reception of current parameters values may be executed. The processor 208A may be configured to receive a current value of each functional parameters associated with the second electronic device 104. For example, the current parameter value 314A of each of the functional parameter associated with the second electronic device 104 may be received. The current parameter value 314A of each functional parameter may be obtained based on the control commands indicated by the user input received by the first electronic device 102. For example, the processor 208A may determine which parameters out of the set of functional parameters 304A are selected for update based on the user input. Thereafter, the processor 208A may transmit a query to the second electronic device 104, based on the selected parameters. The second electronic device 104 may determine current values of each of the selected parameters and transmit the determined current values of the selected parameters to the first electronic device 102. Examples of parameters may include, but are not limited to, the display parameters (such as, the contrast parameter, the color parameter, and the brightness parameter), the audio parameters (such as, the volume level, the sharpness level, and the echo level), and the media parameters (such as, the text font parameter, the resolution size parameter, and the playback speed parameter).

At 316, an operation to render the current functional parameters values may be executed. The processor 208A may be configured to control the first electronic device 102 to render the received current value of the each of the one or more functional parameters. It should be noted that the current values may be received for such functional parameters whose values are required to be changed based on the instructions (i.e., the control commands) in the user input.

In an example, the received current value of each of the one or more functional parameters may include parameters, such as, the display parameter, the audio parameter, or the media parameter. The received current values may be associated with a plurality of functional parameters. The received current value may correspond to the existing values of the plurality of the functional parameters of the second electronic device 104. It is to be noted that the user input may be received based on the control of the rendering of the received current value. In an example, the received current value may correspond to the existing values of the plurality of the functional parameters associated with the second electronic device 104. Further, the first electronic device 102 or the second electronic device 104 may render the existing or current value of each of the plurality of functional parameters. For example, the first electronic device 102 or the second electronic device 104 may display a list of names of the plurality of functional parameters and corresponding current values of each such functional parameter.

At 318, an operation to render a second operational preview may be executed. The processor 208A may be configured to control the first electronic device 102 to render the second operational preview 318A associated with the received current value of each of the one or more functional parameters. It should be noted that the second operational preview may correspond to the preview of the functional parameters (which may be selected based on user input to change such function parameters) on the first electronic device 102. The preview of the functional parameters may render the existing or current values of the one or more functional parameters on the first electronic device 102 and/or on the second electronic device 104. The second operational preview 318A may concurrently display a rendition of the current values of the functional parameters (selected by the user 106 for update) on the first electronic device 102 and/or the second electronic device 104.

In an example, the second operational preview associated with the received current value of each of the one or more functional parameters may include functional parameters, such as, the display parameter, the audio parameter, or the media parameter. The second operational preview associated with the received current values may be associated with preview of plurality of functional parameters concurrently. It is to be noted that the user input may be received based on the control to render the second operational preview. In an example, the second operational preview associated with the receive a current value may be the preview of the existing values of the plurality of the functional parameters on the first electronic device 102 and/or the second electronic device 104. Based on the rendering of the second operational parameter, a decision may be made by the user 106 to update one or more of the functional parameters. Accordingly, the processor 208A may receive the user input to update the values of the one or more functional parameters and thereafter, the processor 208A may control the second electronic device 104 to operate based on the updated values of the one or more functional parameters.

For example, the user 106 may be able to determine appropriate values of the plurality of the functional parameters, based on the preview of the functional parameter on the first electronic device 102. Also, the user 106 may choose from a plurality of combinations of the functional parameters to render the second electronic device 104. Further, the user 106 may preview the user input (indicative of control commands including the changes in the values of the functional parameters) on the first electronic device 102 and preview the rendered functional parameters on the second electronic device 104. Then, the user 106 may provide the appropriate values of the functional parameters according to the preview of the rendered functional parameters on the second electronic device 104.

The present described implementation may be found in the remote controlling of functional parameters and rendering operational previews of electronic devices. Exemplary aspects of the disclosure may provide the first electronic device 102 that may receive the user input indicative of one or more control commands to operate the second electronic device 104 associated with the first electronic device 102. The one or more control commands correspond to a requested set of changes in values of one or more functional parameters of the second electronic device. Next, the first electronic device may determine the requested set of changes in the values of the one or more functional parameters, based on the received user input. Thereafter, the first electronic device may control the second electronic device to operate based on the determined requested set of changes in the values of the one or more functional parameters and control, at least one of the first electronic device or the second electronic device, to render a first operational preview associated with the determined requested set of changes, based on the control of the second electronic device.

The first electronic device 102 of the present disclosure may provide remote control of functional parameters and to render of operational preview of the second electronic device 104. In order to do so, the first electronic device 102 may receive one or more control commands associated with the second electronic device 104 from the user 106. The control commands correspond to a requested set of changes in values of one or more functional parameters of the second electronic device 104. Thereafter, in some embodiments, the first electronic device 102 may determine the requested set of changes in the values of the one or more functional parameters based on the received user input. Further, based on the determined requested set of changes in the values of the one or more functional parameters, the first electronic device 102 may control the second electronic device 104. Upon control of the second electronic device 104, the first electronic device 102 may render a first operational preview associated with the determined requested set of changes. Furthermore, the second electronic device 104 is controlled to render the on-screen display (OSD) menu on the second electronic device 104. The OSD menu corresponds to the one or more functional parameters to be changed. The disclosed first electronic device 102 may receive a current value of the each of the one or more functional parameters and control the first electronic device to render a second operational preview associated with the received current value of the each of the one or more functional parameters. Therefore, the present disclosure may provide the first electronic device 102 that changes plurality of functional parameters concurrently based on the user input. The first electronic device 102 may provide the preview to view the changes in the values of plurality of functional parameters. Also, the second electronic device 104 may display the content with the rendered changes in the values of the functional parameters, and does not display the OSD menu. Thus, viewing of the screen of the second electronic device 104 is not obstructed with the OSD menu.

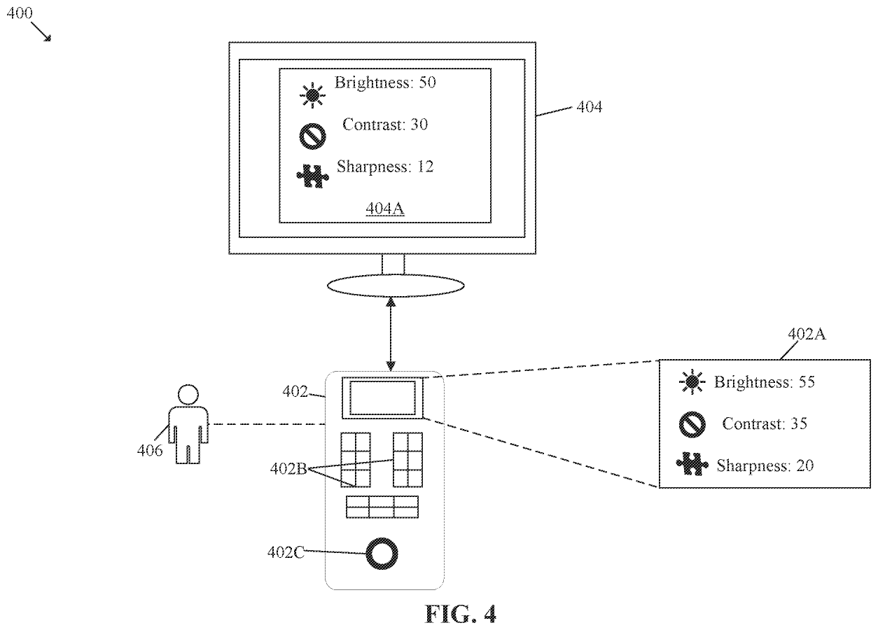

FIG. 4 is a diagram that illustrates an exemplary scenario of a remote controller controlling a display device, in accordance with an embodiment of the disclosure. FIG. 4 is described in conjunction with elements from FIG. 1, FIG. 2A, FIG. 2B, FIG. 3A, and FIG. 3B. With reference to FIG. 4, there is shown an exemplary scenario 400. The scenario 400 may include a remote controller 402, a television (TV) 404, and a user 406. The scenario 400 further illustrates an exemplary previewer 402A, a plurality of buttons 402B, and a knob 402C. Also shown in the scenario 400, the television 404 may display an on-screen display (OSD) menu 404A. In an embodiment, the remote controller 402 may correspond to the first electronic device 102 of FIG. 1 and the television 404 may correspond to the second electronic device 104 of FIG. 1. Therefore, the description of the remote controller 402 and the television 404 is omitted here for the sake of brevity. A set of operations associated the scenario 400 is described herein.

In the scenario 400 of FIG. 4, the remote controller 402 may be configured to control functional parameters of the television 404. Further, the remote controller may be controlled by the user 406, via manual control of the plurality of buttons 402B and the knob 402C. The remote controller 402 or the television 404 may operationally previews a plurality of functional parameters of the television 404. The operational preview may be of the set of plurality of display parameters. For example, as shown in FIG. 4, the previewer 402A may display the operational preview of the plurality of display parameters, such as, the brightness, the contrast, the sharpness, and the like. Each value of the set of display parameters may be in a predefined range of values. The previewer 402A may at first display an updated value of the set of display parameters. Further, the user 406 may provide a user input indicative of one or more control commands to render the existing value of the set of display parameter on the OSD menu 404A on the television 404. Thus, the OSD menu 404A may display the current values of the set of display parameters, while the previewer 402A displays the updated values of the set of the display parameters as provided by the user 406.

It may be noted that the previewer 402A may display existing value of the set of display parameters to the user 406 and further display the change in the values of the set of display parameters as per the user input. The user 406 may provide the user input manually through the buttons 402B or the knobs 402C on the remote controller 402. The values of plurality of display parameters of the television 404 may change according to the received user input. The change in the values of plurality of display parameter may affect display pixels of the television 404. Further, the display of the television 404 may ascertain a combined effect of the changes in the values of plurality of display parameters concurrently. It is to be noted that the display parameters here are associated with the display parameters of the television 404. In case, the display parameters of the television 404 is the brightness parameter, then the predefined range of values for the brightness parameter may be from 0% to 100%. Further, in case the display parameters of the television 404 is the contrast parameter, then the predefined range of values for the contrast parameter may be from 0% to 100%. Furthermore, in case the display parameters of the television 404 is the sharpness parameter, then the predefined range of values for the sharpness parameter may be from 0% to 100%.

With reference to the FIG. 4, the previewer 402A may display the preview of the user input for each of the display parameters. For example, the user 406 provides the user input indicative of the control commands to operate the television 404. The control commands may correspond to a requested set of changes in the values of the display parameters. For example, the user input may request for a change in the value of the brightness parameter from 50% to 55%, the contrast parameter from 30% to 35%, and the sharpness parameter from 12% to 20%, as illustrated in FIG. 4. Hence, the display parameters of the television 404 may be adjusted to display the pixels with the changed values of the display parameters as provided by the user 406. In other words, the plurality of display parameters of the television 404 may be updated concurrently by the user 406.

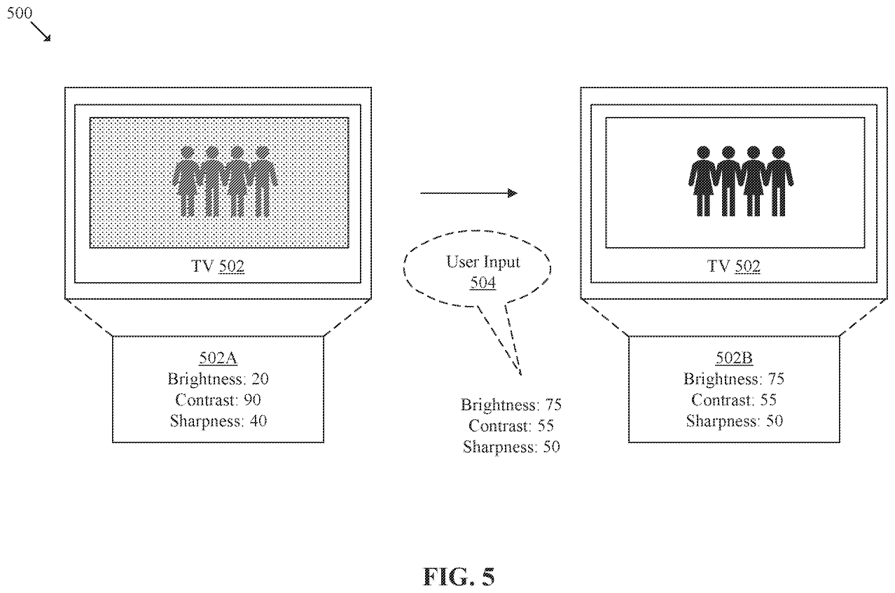

FIG. 5 is a diagram that illustrates an exemplary scenario of change in display pixels according to the user input, in accordance with an embodiment of the disclosure. FIG. 5 is described in conjunction with elements from FIG. 1, FIG. 2A, FIG. 2B, FIG. 3A, FIG. 3B, and FIG. 4. With reference to FIG. 5, there is shown an exemplary scenario 500. The scenario 500 may include a television 502, and a user input 504. The scenario 500 further illustrates an exemplary first preview 502A, and an exemplary second preview 502B. The television 502 may correspond to the second electronic device 104 of FIG. 1. Hence, description of the television 502 has been omitted for the sake of brevity. A set of operations associated the scenario 500 is described herein.

In the scenario 500 of FIG. 5, the television 502 may be configured to render certain content based on current values of display parameters, such as, brightness, contrast, and sharpness. For example, the first preview 502A displays the existing or current values of the display parameters at which the television 502 may be set initially. As an example, as shown in FIG. 5, the current brightness level may be set as 20%, the current contrast level may be set as 90%, and the current sharpness level may be set as 40%. Furthermore, the user 106 may provide the user input 504 to the television 502, through a remote controller (such as, the remote controller 402 of FIG. 4; not shown in FIG. 5), where the user input may indicate a plurality of control commands associated with the set of display parameters of the television 502. It may be noted that the first preview 502A may display the existing value of the set of display parameters and further, the second preview 502B may display the change in the values as per the current values of the set of display parameters. Further, the display of the television 502 may ascertain the combined effect of the changes in the values of plurality of display parameters concurrently.

With reference to the FIG. 5, the first preview 502A may display the existing or current values for each of the display parameters, whereas the second preview 502B may display the updated values for each of the display parameters. For example, the user input 504 provides the control commands to update the display parameters and accordingly operate the television 502. The control commands corresponds to the requested set of changes in the values of the display parameters. Further, the user input 504 may indicate instructions to change the values of the brightness parameter from 20% to 75%, the contrast parameter from 90% to 55%, and the sharpness parameter from 40% to 50%, as illustrated in FIG. 5. Hence, the display parameters of the television 502 may be adjusted according to the user input 504. In other words, the plurality of display parameters of the television 502 may be updated concurrently based on the user input 504.

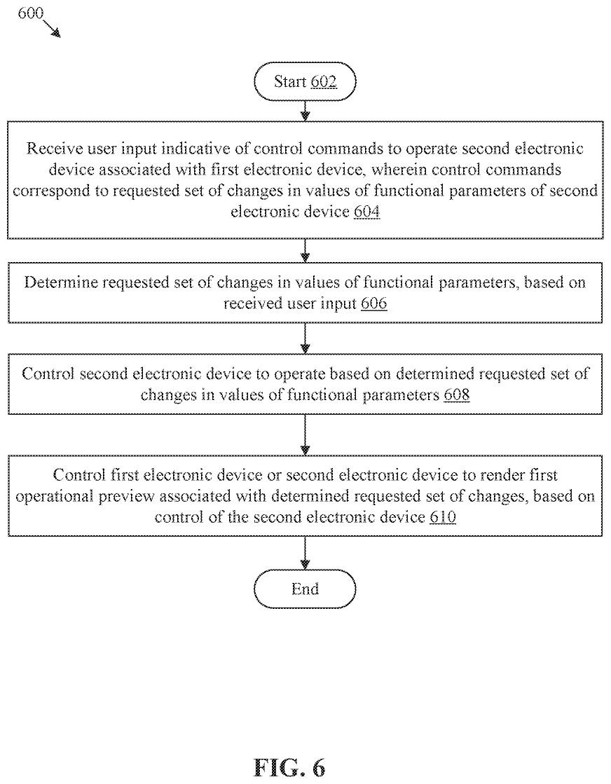

FIG. 6 is a flowchart that illustrates operations of an exemplary method for remotely controlling the functional parameters and rendering of operational preview of the electronic device in accordance with an embodiment of the disclosure. FIG. 6 is described in conjunction with elements from FIG. 1, FIG. 2A, FIG. 2B, FIG. 3A, FIG. 3B, FIG. 4, and FIG. 5. With reference to FIG. 6, there is shown a flowchart 600. The flowchart 600 may include operations from 602 to 612 and may be implemented by the first electronic device 102 of FIG. 1 or by the processor 208A of FIG. 2A or may be implemented by the second electronic device 104 of FIG. 1 or the processor 208B of FIG. 2B. The flowchart 600 may start at 602 and proceed to 604.

At 604, the user input associated with the user 106 may be received. The processor 208A of the first electronic device 102 may be configured to receive the user input associated with the user 106. The user input may be indicative of control commands to operate the second electronic device 104 associated with the first electronic device 102. Further, the control commands indicated by the user input, may correspond to the requested set of changes in values of functional parameters of the second electronic device 104. Details related to the control commands are further described, for example, in FIG. 3A (at 302).

At 606, the requested set of changes in values of functional parameters may be determined, based on the user input. The processor 208A may be configured to determine the requested set of changes in values of functional parameters, based on the user input. Details related to the detection of the requested set of changes in values of functional parameters are further described, for example, in FIG. 3 (at 304).

At 608, the second electronic device 104 may be controlled to be operated based on the determined requested set of changes in the values of the functional parameters. The processor 208A may be configured to control the second electronic device 104 to operate based on the determined requested set of changes in the values of the functional parameters. Details related to control of the second electronic device 104 are further described, for example, in FIG. 3 (at 306).

At 610, the first electronic device 102 or the second electronic device 104 may be controlled based on the user input. The processor 208A or the processor 208B may be configured to control the first electronic device 102 or the second electronic device 104 respectively based on the user input. Details related to the control are further described, for example, in FIG. 3 (at 306 and 308). Furthermore, the first operational preview is rendered associated with the determined requested set of changes in the values of the functional parameters may be rendered based on the control of second electronic device 104. The processor 208A or processor 208B may be configured to render the first operational preview. Details related to the rendering of the first operational preview are further described, for example, in FIG. 3 (at 308 and 310). Control may pass to end.

Although the flowchart 600 is illustrated as discrete operations, such as, 604, 606, 608, and 610 the disclosure is not so limited. Accordingly, in certain embodiments, such discrete operations may be further divided into additional operations, combined into fewer operations, or eliminated, depending on the implementation without detracting from the essence of the disclosed embodiments.

Various embodiments of the disclosure may provide a non-transitory computer-readable medium and/or storage medium having stored thereon, computer-executable instructions executable by a machine and/or a computer to operate an electronic device (for example, the first electronic device 102 and the second electronic device 104 of FIG. 1). Such instructions may cause the first electronic device 102 to perform operations that may include receipt of a user input indicative of control commands. The control commands are received to operate the second electronic device 104 associated with the first electronic device 102. The control commands corresponds to a requested set of changes in values of one or more functional parameters of the second electronic device 104. The operations may further include determination of the requested set of changes in the values of the plurality of functional parameters, based on the received user input. The operations may further include control of the second electronic device 104 to operate based on the determined requested set of changes in the value of the plurality of functional parameters. The operations may further include render a first operational preview associated with the determined requested set of changes by controlling at least one of the first electronic device 102 or the second electronic device 104 (based on the user input associated with the user 106 of FIG. 1.)

Exemplary aspects of the disclosure may provide an electronic device (such as, the first electronic device 102 of FIG. 1) that includes circuitry (such as, the processor 208A). The processor 208A may be configured to receive a user input indicative of control commands. The control commands are received to operate a second electronic device (e.g., the second electronic device 104) associated with the first electronic device 102. The control commands corresponds to a requested set of changes in values of one or more functional parameters of the second electronic device 104. The processor 208A may be configured to determine the requested set of changes in the values of the plurality of functional parameters, based on the received user input. The processor 208A may be configured to control the second electronic device 104 to operate based on the determined requested set of changes in the value of the plurality of functional parameters. The processor 208A may further be configured to render a first operational preview associated with the determined requested set of changes by controlling at least one of the first electronic device 102 or the second electronic device 104 (based on the user input associated with the user 106 of FIG. 1.)

In an embodiment, the one or more functional parameters may correspond to at least one of one or more display parameters, one or more audio parameters, or one or more media parameters, associated with the second electronic device 104.

In an embodiment, the one or more display parameters may correspond to at least one of the contrast parameter, the color parameter, the brightness parameter, the hue parameter, the display sharpness parameter, the display tint parameter, the parameter related to the viewing direction, or the resolution parameter, associated with the second electronic device 104.

In an embodiment, the one or more audio parameters may correspond to at least one of the values of the volume level, the sharpness level, the echo level, the parametric equalizer (EQ), the frequency parameter, the amplitude level, the timber parameter, the decibel level, or the noise cancellation parameter, for audio played on the second electronic device 104.

In an embodiment, the one or more media parameters may correspond to at least one of the text font parameter, the resolution size parameter, the playback speed parameter, the temperature parameter, or the language, associated with media played on the second electronic device 104.

In an embodiment, the processor 208B of the second electronic device 104 may be configured control the second electronic device 104 to render an on-screen display (OSD) menu on the second electronic device 104. Further, the processor 208B may be configured with the OSD menu that corresponds to the one or more functional parameters to be changed.

In an embodiment, the processor 208A may be further configured to control the second electronic device 104 to inactivate the rendered OSD menu on the second electronic device 104, based on the received user input.

In an embodiment, the requested set of changes corresponds to a concurrent update of values of plurality functional parameters of the one or more functional parameters.

In an embodiment, the processor 208A may be further configured to receive a current value of the each of the one or more functional parameters. The processor 208A may be further configured to control the first electronic device 102 to render the received current value of the each of the one or more functional parameters, wherein the user input is received based on the control to render the received current value.

In an embodiment, the processor 208A may be further configured to receive a current value of the each of the one or more functional parameters. The processor 208A may be further configured to control the first electronic device 102 to render a second operational preview associated with the received current value of the each of the one or more functional parameters, wherein the user input is received based on the control to render the second operational preview.

In an embodiment, the first electronic device 102 corresponds to a remote control device (for example, the remote controller 402 of FIG. 4) communicatively coupled to the second electronic device 104.

In an embodiment, the second electronic device 104 corresponds to a media playback device (for example the television 404 of FIG. 4).

The present disclosure may also be positioned in a computer program product, which comprises all the features that enable the implementation of the methods described herein, and which when loaded in a computer system is able to carry out these methods. Computer program, in the present context, means any expression, in any language, code or notation, of a set of instructions intended to cause a system with information processing capability to perform a particular function either directly, or after either or both of the following: a) conversion to another language, code or notation; b) reproduction in a different material form.

While the present disclosure is described with reference to certain embodiments, it will be understood by those skilled in the art that various changes may be made, and equivalents may be substituted without departure from the scope of the present disclosure. In addition, many modifications may be made to adapt a particular situation or material to the teachings of the present disclosure without departure from its scope. Therefore, it is intended that the present disclosure is not limited to the embodiment disclosed, but that the present disclosure will include all embodiments that fall within the scope of the appended claims.

What is claimed is:

1. A first electronic device, comprising:
circuitry configured to:
receive a user input indicative of one or more control commands to operate a second electronic device associated with the first electronic device, wherein
the one or more control commands correspond to a requested set of changes in values of one or more functional parameters of the second electronic device;
determine the requested set of changes in the values of the one or more functional parameters, based on the received user input;
control the second electronic device to operate based on the determined requested set of changes in the values of the one or more functional parameters; and
control, at least one of the first electronic device or the second electronic device, to render a first operational preview associated with the determined requested set of changes, based on the control of the second electronic device.

2. The first electronic device according to claim 1, wherein the one or more functional parameters correspond to at least one of one or more display parameters, one or more audio parameters, or one or more media parameters, associated with the second electronic device.

3. The first electronic device according to claim 2, wherein the one or more display parameters correspond to at least one of a contrast parameter, a color parameter, a brightness parameter, a hue parameter, a display sharpness parameter, a display tint parameter, a parameter related to a viewing direction, or a resolution parameter, associated with the second electronic device.

4. The first electronic device according to claim 2, wherein the one or more audio parameters correspond to at least one of a volume level, a sharpness level, an echo level, a parametric equalizer (EQ), a frequency parameter, an amplitude level, a timber parameter, a decibel level, or a noise cancellation parameter, for audio played on the second electronic device.

5. The first electronic device according to claim 2, wherein the one or more media parameters correspond to at least one of a text font parameter, a resolution size parameter, a playback speed parameter, a temperature parameter, or a language, associated with media played on the second electronic device.

6. The first electronic device according to claim 1, wherein the second electronic device is configured to:
control the second electronic device to render an on-screen display (OSD) menu on the second electronic device, wherein
the OSD menu corresponds to the one or more functional parameters to be changed.

7. The first electronic device according to claim 6, wherein the circuitry is further configured to control, based on the received user input, the second electronic device to inactivate the rendered OSD menu on the second electronic device.

8. The first electronic device according to claim 1, wherein the requested set of changes corresponds to a concurrent update of values of a plurality functional parameters of the one or more functional parameters.

9. The first electronic device according to claim 1, wherein the circuitry is further configured to:
receive a current value of the each of the one or more functional parameters; and
control the first electronic device to render the received current value of the each of the one or more functional parameters, wherein
the user input is received based on the control to render the received current value.

10. The first electronic device according to claim 1, wherein the circuitry is further configured to:
receive a current value of the each of the one or more functional parameters; and
control the first electronic device to render a second operational preview associated with the received current value of the each of the one or more functional parameters, wherein
the user input is received based on the control to render the second operational preview.

11. The first electronic device according to claim 1, wherein
the first electronic device corresponds to a remote control device communicatively coupled to the second electronic device, and
the second electronic device corresponds to a media playback device.

12. A method, comprising:
in a first electronic device:
receiving a user input indicative of one or more control commands to operate a second electronic device associated with the first electronic device, wherein
the one or more control commands correspond to a requested set of changes in values of one or more functional parameters of the second electronic device;
determining the requested set of changes in the values of the one or more functional parameters, based on the received user input;
controlling the second electronic device to operate based on the determined requested set of changes in the values of the one or more functional parameters; and
controlling, at least one of the first electronic device or the second electronic device, to render a first operational preview associated with the determined requested set of changes, based on the control of the second electronic device.

13. The method according to claim 12, wherein the one or more functional parameters correspond to at least one of one or more display parameters, one or more audio parameters, or one or more media parameters, associated with the second electronic device.

14. The method according to claim 12, wherein the second electronic device is configured to:
control the second electronic device to render an on-screen display (OSD) menu on the second electronic device, wherein
the OSD menu corresponds to the one or more functional parameters to be changed.

15. The method according to claim 14, further comprising controlling, based on the received user input, the second electronic device to inactivate the rendered OSD menu on the second electronic device.

16. The method according to claim 12, wherein the requested set of changes corresponds to a concurrent update of values of a plurality functional parameters of the one or more functional parameters.

17. The method according to claim 12, further comprising:
receiving a current value of the each of the one or more functional parameters; and
controlling the first electronic device to render the received current value of the each of the one or more functional parameters, wherein
the user input is received based on the control to render the received current value.

18. The method according to claim 12, further comprising:
receiving a current value of the each of the one or more functional parameters; and
controlling the first electronic device to render a second operational preview associated with the received current value of the each of the one or more functional parameters, wherein
the user input is received based on the control to render the second operational preview.

19. The method according to claim 12, wherein
the first electronic device corresponds to a remote control device communicatively coupled to the second electronic device, and
the second electronic device corresponds to a media playback device.

20. A non-transitory computer-readable medium having stored thereon, computer-executable instructions that when executed by a first electronic device, causes the first electronic device to execute operations, the operations comprising:
receiving a user input indicative of one or more control commands to operate a second electronic device associated with the first electronic device, wherein
the one or more control commands correspond to a requested set of changes in values of one or more functional parameters of the second electronic device;
determining the requested set of changes in the values of the one or more functional parameters, based on the received user input;
controlling the second electronic device to operate based on the determined requested set of changes in the values of the one or more functional parameters; and
controlling, at least one of the first electronic device or the second electronic device, to render a first operational preview associated with the determined requested set of changes, based on the control of the second electronic device.
